(19) United States
(12) Patent Application Publication
(10) Pub. No.: US 2008/0229793 A1
(43) Pub. Date: Sep. 25, 2008

(54) Schliebetazylinder Mit gesperrter Knaufwelle

(75) Inventor: Volker LANGE, Quickborn (DE)

Correspondence Address: SHERIDAN ROSS PC, 1560 BROADWAY, SUITE 1200, DENVER, CO, 80202, US

(73) Assignee: BUGA TECHNOLOGIES GMBH, Norderstedt (DE)

(21) Appl. No.: 11/424,436

(22) Filed: Jun. 15, 2006

(30) Foreign Application Priority Data
Jun. 24, 2005 (EP) 05013638.1

(51) Int. Cl. E05B 49/00; E05B 9/04

(52) U.S. Cl. 70/278.3; 70/370

(57) ABSTRACT

The invention concerns a lock cylinder with a lock cylinder housing, having at least one hollow cylindrical receptacle, in which a rotating part is mounted to rotate, which is connected to rotate in unison with a lock element, and with at least one coupling device, which moves at least one blocking element between a locked position, in which it is engaged with an abutment in the rotating part or the lock cylinder housing and blocks rotation between the rotating part and blocking cylinder housing, and a released position, in which it is disengaged from the abutment and permits rotation between the rotating part and the lock cylinder housing. According to the invention, it is proposed that along the peripheral region of the rotating part of the lock cylinder housing, which is swept by the blocking element during one revolution of the rotated part, at least two and preferably several abutments are provided in the peripheral direction, into which the blocking element can engage.

The invention concerns a lock cylinder with a lock cylinder housing, having at least one hollow cylindrical receptacle, in which a rotating part is mounted to rotate, which is connected to rotate in unison with a lock element, and with at least one coupling device, which moves at least on blocking element between a locked position, in which it engages with an abutment in the rotating part or the lock cylinder housing and blockings rotation between the rotating part and the lock cylinder housing, and a loose position, in which it is disengaged from the abutment and permits rotation between the rotating part and lock cylinder housing.

Such lock cylinders are generally known. The arrangement of often such that an input signal is recorded by means of an antenna, which excites a transponder in a chip or similar token, worn by the person being granted access. The received input signal contains the access code, which is evaluated by evaluation electronics. In the case of access authorization, an authorization signal is generated, which drives an electromechanical coupling device. The coupling device causes rotation-free connection between the lock element, for example, a lock tab, and the knob shaft. Operation of the lock or a switch or the like is then possible with the lock cylinder.

DE 103 28 297 A1 describes the arrangement of a lock tab on a rotating sleeve, mounted to rotate freely on a knob shaft. The coupling device is arranged in the knob shaft, which, based on the authorization signal of a driver, drives the rotary sleeve in a recess. The lock tab is therefore connected to rotate in unison with the knob shaft. DE 198 51 308 C2 discloses a lock cylinder that can be operated on both sides by a knob. The evaluation electronics and the antenna to receive a signal transmitted in wireless fashion are arranged in the knob on the inside of the door. The lock tab here is also connected by the coupling device to rotate in unison with the knob shaft.

Locks, lock cylinders or lock systems operable with keys are known, in which the lock element is always connected to rotate in unison with the lock core. Such lock cylinders mostly find use in North American countries. The lock core here cannot be easily replaced by a knob shaft with a knob having evaluation electronics with the antenna to receive an input signal. In lock cores that are operated with a key, there is a defined pullout position of the key and therefore a defined rotation position of the lock core relative to the lock cylinder housing, which also permits defined engagement of the blocking element and thus permits electromechanical lock. This is not the case in lock cylinders operable with a knob, but instead the knob can be released in any position. The lock can then still be operated.

The underlying task of the invention is to design a lock cylinder operable with a knob of the type just outlined, so that reliable electromechanical lock is possible.

The task is solved according to the invention in that along the peripheral region of the rotating part or the lock cylinder housing, which is swept during one revolution of the rotating part of the blocking element, at least two and preferably several abutments are present in the peripheral direction, into which the blocking element can engage. This has the advantage that, in contrast to only one abutment, the rotating part can no longer execute almost an entire revolution until it engages the blocking element. Instead, with two abutments, only a maximum of one-half revolution will be possible. In particular, the number of abutments and therefore the maximum free angle of rotation of the rotating part can be chosen, so that operation of the lock is impossible.

It can be prescribed that at least one coupling device with at least one blocking element is arranged in the rotating part. The abutments are then situated in the lock cylinder housing. As an alternative, it can be prescribed that at least one coupling device with at least one blocking element is arranged in the lock cylinder housing. The abutments are then present in the rotating part. However, it is also possible to arrange at least one coupling device and a blocking element in the rotating part and at least one coupling device and a blocking element in the lock cylinder housing. Which expedient is employed also depends on the design details and the manner, in which the coupling device is driven.

In principle, it will be sufficient, if a blocking element cooperates with at least one abutment of a number of abutments, into which the blocking element can engage. The angle of rotation can be minimized by a small spacing. However, it can also be expedient, if the position of the blocking elements and/or the position of the abutment cooperating with them, when at least two blocking elements are present, is chosen in the peripheral direction, so that at least one locked position, which is produced by engagement of one of the blocking elements, lies between two locked positions in the peripheral direction that are caused by the other blocking element. The maximum possible free angle of rotation, until snapping into the next closest abutment, is further reduced on this account. This can be favorable in sensitive lock cylinders, which operate, for example, only one electrical switch contact.

The coupling device can drive two blocking elements offset in the peripheral direction. It is also possible that the blocking elements have an axial spacing relative to each other.

It is expedient if the abutments are designed as recesses in the lock cylinder housing or rotating part arranged in the peripheral direction with a spacing relative to each other. The blocking element then comprises a blocking pin, which advantageously can be moved back and forth in the radial direction by the coupling device.

It is particularly expedient if the blocking element can be compressed in its movement direction against the force of a spring, so that in a position of the coupling device corresponding to the locked position and not engagement with an abutment, it is biased for engagement in an abutment. A situation is achieved by this in which the blocking element will always engage in the next recess when the rotating element is rotated and the locked position is to be assumed, i.e., in the lock cylinder being locked.

The coupling device can include an electromechanical, electric motor or electromagnetic drive that can be driven by an authorization signal. The authorization signal can be produced by a known evaluation electronics, which records and evaluates an input signal transmitted in wireless fashion, an input via a keypad, an input based on a recorded biometric feature or the like.

The rotating part is a knob shaft connected to rotate in unison with the lock element and to rotate in unison with the knob. The knob can include all the required electronic and electrical assemblies, like the reading unit for the input signal, evaluation electronics and power supply.

The invention is further explained below by means of a schematic drawing. In the drawing:

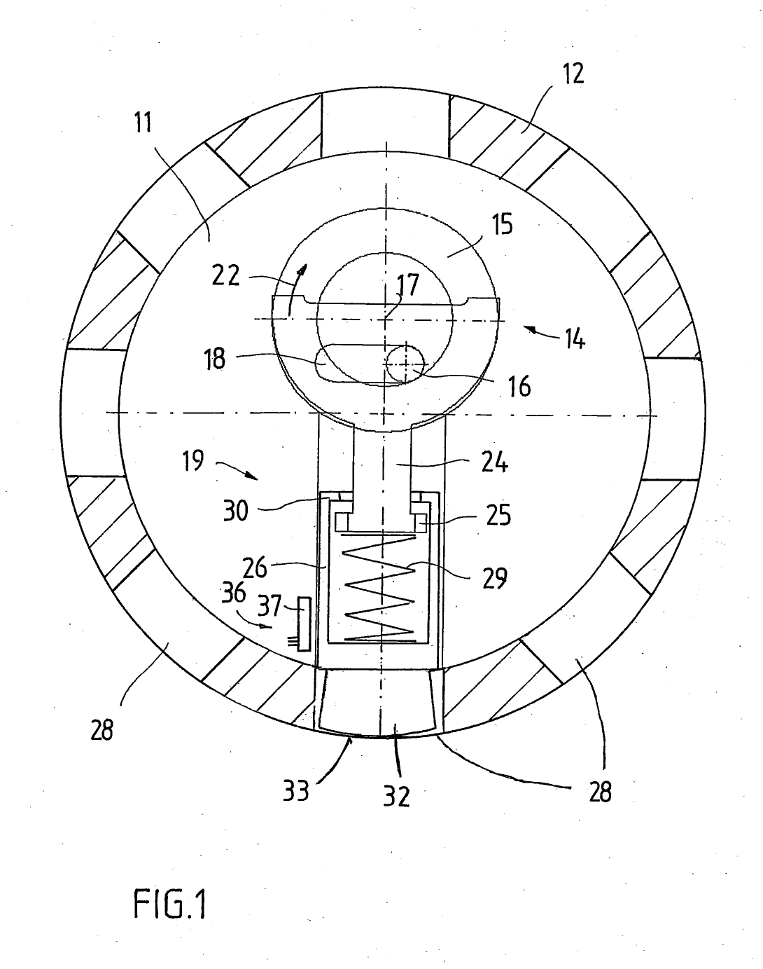

FIG. 1 shows a view of the rotating part with the blocking element in the locked position,

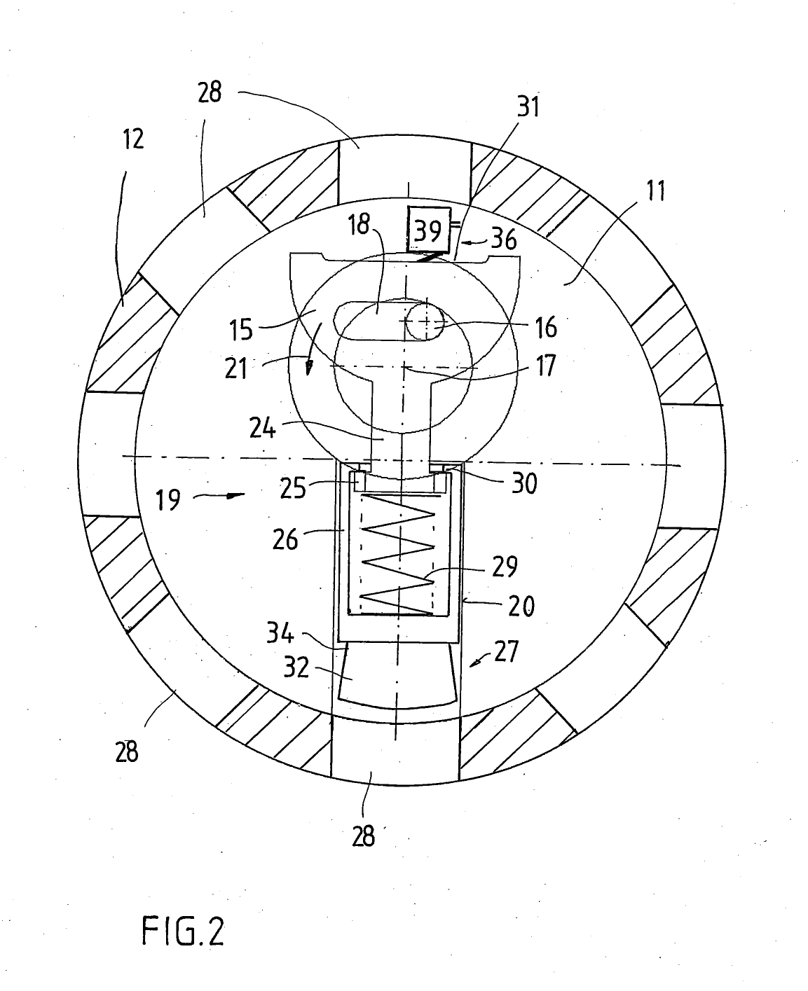

FIG. 2 shows a view of the rotating part with the blocking element in the released position and

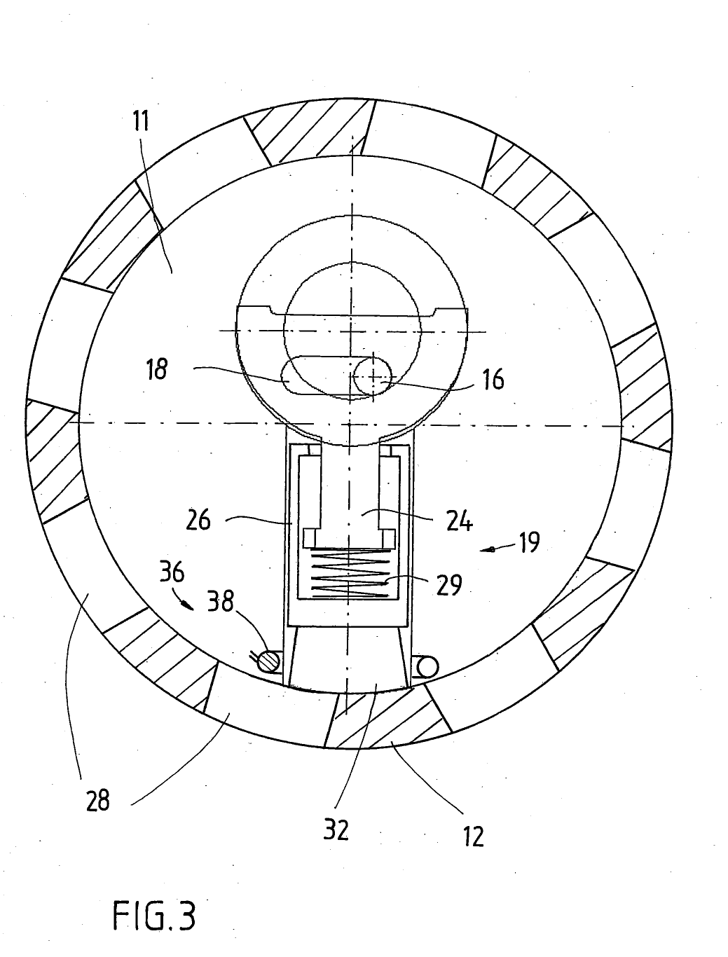

FIG. 3 shows a view of the rotating part in an intermediate position of the blocking element.

The rotating part 11 depicted in the drawing is mounted to rotate in a hollow cylindrical receptacle 12 of a lock cylinder (not further shown). The receptacle 12 and the lock cylinder housing can be firmly connected to the lock, or also integrated in a handle. The rotating part can be a knob shaft that can be rotated with a knob. Evaluation electronics (not shown) with electronic devices that can query and evaluate in known fashion an electronic access code of a key element are also provided.

When access authorization is recognized, an authorization signal is generated, which activates an electromechanically operating coupling device 14, which releases the lock according to FIG. 1 between the rotating part and the lock cylinder housing. The lock cylinder can then be operated by rotating the knob shaft 11 with the rotating knob. The lock cylinder, in terms of basic design, dimensions, and especially in terms of electronic recording and evaluation of the access code, corresponds in this respect to an ordinary electromechanical lock cylinder and therefore requires no further explanation.

The specific arrangement is such, that the rotating part is mounted to rotate in the housing. The coupling device 14 is arranged in the rotating part 11 and includes a cam with a rotor 15, on which an axially extending driver 16 is arranged eccentrically to the cam axis 17. The drive 16 cooperates via a groove 18 with a blocking element 19, which is moved back and forth in the radial direction, because of the rotational movement of the rotor. The blocking element 19 is guided for this purpose in a guide channel 20 of the rotating part 11 linearly and in a radial direction relative to the rotating part.

The groove 18 essentially extends across the direction of stroke of the blocking element 19. The position and length of the groove are chosen, so that, starting from the released position depicted in FIG. 2, the blocking element 19 can be brought into the locked position depicted in FIG. 1 merely by rotation of rotor 15 in direction of rotation 21. The blocking element can only be brought from the locked position back into the rest position by rotation in direction 22.

The length and position of the groove are also chosen, so that the cam, in its end positions, can be rotated by an angle of rotation beyond dead center of the corresponding position. This angle can be 10° to 30°, for example. Because of this, the blocking element does experience a return movement, but this return stroke, relative to the total stroke between the released position and the locked position, is limited and has no effect on the blocking or release function of the blocking element. However, the area of the groove shown in the drawing on the right is dimensioned, so that further rotation of the rotor in the direction of rotation 22 by more than the stipulated angle of rotation beyond top dead center, which corresponds to the released position of the blocking element, is not possible, since the driver 16 is stopped beforehand against the front limitation of groove 18.

The same applies for a movement in direction of rotation 21 beyond bottom dead center, which corresponds to the locked position of the blocking element. A situation is therefore achieved in which the driver is held by the cam and the corresponding end position is firmly held by the cam in the corresponding end position, since complete back rotation is only possible beyond dead center, but in the opposite direction. The corresponding end position is therefore always reliably reached and held when the drive motor of the cam is driven sufficiently long with power for rotation in one or the other direction.

The blocking element 19 has a cam follower 24, whose one end carries groove 18 and is mounted on the pin 16 of the cam. The free end 25 of the cam follower is guided in a sleeve 26. The opposite free end 27 of the sleeve protrudes into one of the recesses 28 in receptacle 12 of the lock cylinder housing in the locked position, depicted in FIG. 1. A rotation-proof connection between the rotating part and the lock cylinder housing is then present, and the lock is blocked.

A compression spring 29 is arranged in the interior of sleeve 26, which cooperates with the free end of the cam follower. A stop 30, against which the thickened end 25 of cam follower 24 abuts, is present on the side of sleeve 26 opposite the free end. The sleeve is then securely held against the cam follower. A situation is achieved by this arrangement in which the cam follower can also be moved by the cam from the position of the driver corresponding to the released position of the blocking element, when the guide channel 20, as shown in FIG. 3, is not flush with the recess 28. The free end 27 of the blocking element instead lies against the inside wall of receptacle 12 and the compression spring is compressed. The free end 27 first snaps into one of the following recesses 28 during a rotational movement of the rotating part, as soon as the free end 27 goes beyond the corresponding recess. Reliable locking is therefore achieved, before further rotation could lead to undesired operation of the lock.

Since the rotating part 11 is always firmly connected to a lock element, for example, a lock tab, one recess 28 is not sufficient, in order to prevent unauthorized operation of the lock reliably. With an unfavorable position of the blocking element, the rotating part 11 could be moved along the periphery of the receptacle 12 almost an entire revolution, if only one recess is present, until the blocking element engages.

Consequently, along the peripheral region that is swept by the blocking element 19 during a revolution, several recesses 28 are present. In the practical example depicted in the drawing, eight recesses are present symmetrically along the periphery. The rotating part can therefore be rotated a maximum of 45°, until the blocking element reaches the next recess. Operation of the lock is therefore prevented.

However, more or fewer recesses could also be provided with an asymmetric distribution. This can depend, in particular, on the mechanism of the lock being operated, the angle of rotation and therefore the spacing of the recesses that is maximally admissible. The arrangement can also be chosen here, so that in the region of the lock point or switching point, several recesses lie more closely to each other than in the other area of the periphery, in which only free rotation of the lock element occurs anyway without effective operation of the lock.

The free end 27 of the sleeve is also designed as a widening protrusion 32 with a narrower neck region 34 and a rounded-off face. Reliable snapping-in of the protrusion is therefore achieved when the recess 28 is traversed with the biased spring 29.

It is also prescribed that the recess 28 in the introduction direction of the blocking element is closed or has a stop 33, in which the depth of the recess is chosen, so that the compression spring 29 is still under stress when the protrusion 32 is inserted, and the free end 25 of the cam follower still does not lie against stop 30. A situation is therefore achieved, in which the driver 16 is held under stress via the cam follower and the groove in the end position of the cam corresponding to the locked position above the corresponding dead center. The cam can then no longer be rotated back by itself, for example, by gravity, even when the power supply of the drive motor is interrupted.

For perfect functioning of the lock cylinder even under unfavorable conditions, it is essential to know the position of the coupling element. In particular, when the lock cylinder is not to be operated, it is important to guarantee that the blocking element is situated in the locked position. In principle, it is possible to drive the coupling agent, for example, the cam motor, by the evaluation electronics that are present anyway after operation of the lock cylinder, several times at time intervals, so that it enters the locked position. Even here, it is not always ensured that the blocking element 19 is actually situated in the deployed and engaged locked position.

It can therefore be prescribed that means of recording 36 are present that record the position of the blocking element. The means of recording can include at least one Hall sensor 37 and/or at least one capacitive or inductive sensor 38 or a switch 39 that cooperates with a moving element of the coupling device of the blocking element. In FIG. 1, a Hall sensor 37 and in FIG. 3 a capacitive sensor 38, in the form of a capacitor arrangement of half-rings are shown, which are influenced based on the position of the driver. The driver preferably consists of metal, so that its position in front of the Hall sensor or between the capacitor rings can be properly detected.

FIG. 2 shows an end switch 39, which cooperates with the cam of the motor. The end switch can be designed as a pushbutton, which simultaneously applies the spring force, in order to keep the driver in the rest position behind the top dead center of the cam.

A signal can be generated by the sensors or the switch that corresponds to the position of the blocking element, and especially its protrusion 32. A signal can be present when the coupling device or the blocking element or the protrusion 32 is situated in the released position or the locked position. It can therefore be established that the coupling device is in the locked position, but the blocking element has still not engaged in a recess. An alarm signal can then be generated that is visible on the lock cylinder itself or a central office. If possible, a drive device for the rotating part can be driven, so that the rotating part moves to engagement of the blocking element in the next recess.

A lock cylinder with an electric motor coupling device with a cam drive was described above. Naturally, it is also possible to drive the blocking element with another coupling device, especially with an electromagnet or a rotating magnet.

In the depicted arrangement, the coupling device is also arranged in the rotating part. It is naturally also possible to arrange the coupling device in a fixed lock cylinder housing. Several recesses would then be present in the rotating part along the peripheral region of the rotating part that travels above the blocking element.

When several blocking elements are present, which can be spaced from each other in the axial direction, the recesses or the blocking elements can be arranged offset in the peripheral direction. Either one or the other blocking element then engages into the next recess, so that the free angle of rotation becomes even smaller. It is also possible that a coupling device drives two blocking elements that lie on the same periphery, but with a different division. For example, if the division of the recesses is 45°, the blocking elements can have a spacing relative to each other that corresponds to an angle of rotation deviating from a whole number multiple n of 45°, for example, 157.50° or n×45°+22.5°. The free angle of rotation can therefore also be reduced.

1. Lock cylinder with a lock cylinder housing, having at least one hollow cylindrical receptacle (12), in which a rotating part (11) is mounted to rotate, which is connected to rotate in unison with a lock element, and with at least one coupling device (14), which moves at least one blocking element (19) between a locked position, in which it is engaged with an abutment (28) in the rotating part or the lock cylinder housing and blocks rotation between the rotating part and the lock cylinder housing, and a released position, in which it is disengaged from the abutment and permits rotation between the rotating part and lock cylinder housing, characterized by the fact that along the peripheral region of the rotating part or the lock cylinder housing, which is swept during one revolution of the rotating part by the blocking element, at least two and preferably several abutments (28) are present in the peripheral direction, which can be engaged with the blocking element (19).

2. Lock cylinder according to claim 1, characterized by the fact that at least one coupling device (14) with at least one blocking element (19) is arranged in the rotating part.

3. Lock cylinder according to claim 1, characterized by the fact that at least one coupling device with at least one blocking element is arranged in the lock cylinder housing.

4. Lock cylinder according to one of the claims 1 to 3, characterized by the fact that at least one coupling device and a blocking element are arranged in the rotation part and at least one coupling device and a blocking element are arranged in the lock cylinder housing.

5. Lock cylinder according to one of the claims 1 to 4, characterized by the fact that when at least two blocking elements are present, the position of the blocking elements and/or the position of the abutments cooperating with them in the peripheral direction is chosen, so that at least one locked position, which is produced by engagement of one blocking element, lies between two locked positions in the peripheral direction that are produced by the other blocking element.

6. Lock cylinder according to one of the claims 1 to 5, characterized by the fact that a coupling device drives two or more blocking elements.

7. Lock cylinder according to one of the claims 1 to 6, characterized by the fact that the abutments are designed as recesses (28) in the lock cylinder housing arranged at a spacing from each other in the peripheral direction.

8. Lock cylinder according to one of the claims 1 to 6, characterized by the fact that the abutments are designed as recesses in the rotating part arranged with a spacing from each other in the peripheral direction.

9. Lock cylinder according to one of the claims 1 to 8, characterized by the fact that the blocking element (19) can be compressed in its movement direction against the force of a spring (29), so that it is biased for engagement in an abutment in a position of the coupling device that corresponds to the locked position and is not engaged with an abutment (28).

10. Lock cylinder according to one of the claims 1 to 9, characterized by the fact that the coupling device (14) includes an electromechanical, electric motor or electromagnetic drive that can be driven based on an authorization signal.

11. Lock cylinder according to one of the claims 1 to 10, characterized by the fact that the rotating part (11) is a knob shaft connected to rotate in unison with a knob.
